(19) United States
(12) Patent Application Publication
(10) Pub. No.: US 2025/0113373 A1
(43) Pub. Date: Apr. 3, 2025

(54) TRANSMISSION OF LOW PRIORITY DATA USING CONFIGURED UPLINK GRANTS

(71) Applicant: Apple Inc., Cupertino, CA (US)

(72) Inventors: ChunLei Lin, Hong Kong (HK); Bin Feng, Beijing (CN); Dhiraj J. Shirke, San Jose, CA (US); Kok Yin Chan, Hornsby (AU); Muthukumaran Dhanapal, San Diego, CA (US); Pranav Tripathi, San Jose, CA (US); Sanjeevi Balasubramanian, San Jose, CA (US)

(21) Appl. No.: 18/374,649

(22) Filed: Sep. 28, 2023

(51) Int. Cl. H04W 72/566; H04W 72/1268

(52) U.S. Cl. CPC H04W 72/569; H04W 72/1268

(57) ABSTRACT

Disclosed are methods, systems, and computer-readable media to perform operations including: receiving an uplink grant associated with pre-scheduling from a base station; in response to the uplink grant, transmitting first data having a first priority to the base station; determining whether there is a remaining uplink resource associated with the uplink grant; and in response to determining that there is the remaining uplink resource, transmitting second data having a second priority to the base station using the remaining uplink resource, wherein the second priority is lower than the first priority.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A user equipment (UE) uses a Scheduling Request (SR) or a Buffer Status Report (BSR) to transmit data to a base station. The SR is a message sent by the UE when it has immediate data to transmit and requires uplink resources promptly. The SR is used for low-latency or real-time applications where the UE cannot wait for periodic resource allocations. The SR indicates to the network that the UE has data ready for transmission and requires resources as soon as possible. The BSR is sent periodically by the UE to inform the network about the status of data in its buffer. The BSR provides information about the amount of data waiting to be transmitted, and it can also indicate the priority and type of data (e.g., real-time or non-real-time). The network uses this information to make resource allocation decisions.

### SUMMARY

According to one innovative aspect of the present disclosure, one or more processors of a user equipment (UE) configured to perform operations for transmission of low priority data using configured uplink grants are disclosed. In one aspect, the operations can include: receiving an uplink grant associated with pre-scheduling from a base station; in response to the uplink grant, transmitting first data having a first priority to the base station; determining whether there is a remaining uplink resource associated with the uplink grant; and in response to determining that there is the remaining uplink resource, transmitting second data having a second priority to the base station using the remaining uplink resource, wherein the second priority is lower than the first priority.

Other aspects include methods, apparatuses, systems, and computer programs for performing the aforementioned operations.

The innovative operations can include other optional features. For example, in some implementations, the operations further include: in response to determining that there is no remaining uplink resource, receiving, from the base station, at least one subsequent uplink grant associated with the pre-scheduling; and in response to receiving the at least one subsequent uplink grant, transmitting the second data to the base station.

In some implementations, the operations further include: in response to determining that there is no remaining uplink resource, transmitting a scheduling request (SR) or Buffer Status Report (BSR) to the base station; in response to transmitting the SR or the BSR to the base station, receiving a second uplink grant; and in response to receiving the second uplink grant, transmitting the second data to the base station.

In some implementations, the operations further include: determining whether a size of the remaining uplink resource is greater than a data size of the second data; and in response to determining that the size of the remaining uplink resource is greater than the data size of the second data, transmitting the second data to the base station.

In some implementations, the operations further include: in response to determining that the size of the remaining uplink resource is equal to or less than the data size of the second data, transmitting a portion of the second data to the base station. A data size of the portion of the second data is equal to or less than the size of the remaining uplink resource.

In some implementations, transmitting the portion of the second data further includes: determining remaining delay budget cycles for the second data; determining that the remaining delay budget cycles are greater than a predetermined number of Connected-Mode Discontinuous Reception (CDRX) cycles; in response to determining that the remaining delay budget cycles are greater than the predetermined number of CDRX cycles, transmitting the portion of the second data to the base station.

In some implementations, the remaining delay budget cycles=(a delay budget of the second data−(current time point−arrival time point of the second data))/duration of a CDRX cycle.

In some implementations, the operations further include: in response to determining that the size of the remaining uplink resource is equal to or less than the data size of the second data, transmitting a scheduling request (SR) or a Buffer Status Report (BSR) to the base station; in response to transmitting the SR or BSR to the base station, receiving a second uplink grant; and in response to receiving the second uplink grant, transmitting the second data to the base station.

In some implementations, transmitting the second data further includes: determining remaining delay budget cycles for the second data; determining that the remaining delay budget cycles are greater than a predetermined number of Connected-Mode Discontinuous Reception (CDRX) cycles; in response to determining that remaining delay budget cycles are greater than the predetermined number of CDRX cycles, transmitting the second data to the base station.

In some implementations, the remaining delay budget cycles=(a delay budget of the second data−(current time point−arrival time point of the second data))/duration of a CDRX cycle.

In some implementations, the at least one subsequent uplink grant includes two or more subsequent uplink grants, wherein transmitting the second data further includes: splitting the second data into a plurality of portions; and transmitting each of the plurality of portions in response to a respective subsequent uplink grant.

In some implementations, the first data is audio data and/or video data, and the second data is background data.

According to another innovative aspect of the present disclosure, one or more processors of a user equipment (UE) configured to perform operations for transmission of low priority data using configured uplink grants are disclosed. In one aspect, the operations can include: suspending a scheduling request (SR) or a Buffer Status Report (BSR); receiving an uplink grant associated with pre-scheduling from a base station; determining whether a size of an uplink resource associated with the uplink grant is equal to or greater than a data size of background data; and in response to determining that the size of the uplink resource is equal to or greater than the data size of the background data, transmitting the background data to the base station.

Other aspects include methods, apparatuses, systems, and computer programs for performing the aforementioned operations.

The innovative operations can include other optional features. For example, in some implementations, the operations further include: in response to determining that the size of the uplink resource is less than the data size of the background data, splitting the background data into a plurality of portions; receiving, from the base station, a plurality of uplink grants associated with the pre-scheduling; in response to receiving the plurality of uplink grants, transmitting each of the plurality of portions in response to a respective uplink grant.

In some implementations, the operations further include: in response to determining that the size of the uplink resource is less than a data size of the background data, transmitting a portion of the background data and Buffer Status Report (BSR) associated with remaining background data to the base station; receiving, from the base station, a second uplink grant immediately after transmitting the portion of the background data and the BSR associated with the remaining background data; in response to receiving the second uplink grant, transmitting the remaining background data corresponding to the BSR to the base station.

In some implementations, an on-duration of a Connected-Mode Discontinuous Reception (CDRX) cycle is prolonged until completion of transmitting the remaining background data.

According to another innovative aspect of the present disclosure, one or more processors of a user equipment (UE) configured to perform operations for transmission of low priority data using configured uplink grants are disclosed. In one aspect, the operations can include: receiving, from a base station, a plurality of uplink grants associated with pre-scheduling, wherein the plurality of uplink grants are received within a delay budget of background data; splitting the background data into a plurality of portions; appending each of the plurality of portions to audio data associated with a respective uplink grant; and transmitting audio data appended with each of the plurality of portions to the base station in response to the respective uplink grant.

Other aspects include methods, apparatuses, systems, and computer programs for performing the aforementioned operations.

According to another innovative aspect of the present disclosure, one or more processors of a user equipment (UE) configured to perform operations for transmission of low priority data using configured uplink grants are disclosed. In one aspect, the operations can include: receiving first background data having a first priority and a delay budget; receiving, within the delay budget, second background data having a second priority, wherein the first priority is lower than the second priority; transmitting, to a base station, a scheduling request (SR) or a Buffer Status Report (BSR) associated with the second background data; in response to transmitting the SR or BSR to the base station, receiving an uplink grant from the base station; in response to receiving the uplink grant, appending at least a portion of first background data to the second background data; and transmitting, to the base station, the second background data appended with at least the portion of the first background data.

Other aspects include methods, apparatuses, systems, and computer programs for performing the aforementioned operations.

According to another innovative aspect of the present disclosure, one or more processors of a user equipment (UE) configured to perform operations for transmission of low priority data using configured uplink grants are disclosed. In one aspect, the operations can include: receiving background data having a delay budget; in response to determination that the delay budget is set to expire; transmitting a scheduling request (SR) or a Buffer Status Report (BSR) to a base station; in response to transmitting the SR or BSR to the base station, receiving an uplink grant from the base station; and in response to receiving the uplink grant, transmitting at least a portion of the background data to the base station prior to expiration of the delay budget.

Other aspects include methods, apparatuses, systems, and computer programs for performing the aforementioned operations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2A illustrates an example graph of data packets of UE, according to some implementations.

FIG. 2B illustrates an example graph of baseband states of UE, according to some implementations.

FIG. 3 illustrates another example graph of data packets of UE, according to some implementations.

FIG. 4 illustrates another example graph of data transmission in a silent state of UE, according to some implementations.

FIG. 5 illustrates a flow chart of transmission of low priority data in a silent state of UE, according to some implementations.

FIG. 6 illustrates another example graph of data transmission in a talk state of UE, according to some implementations.

FIG. 7 illustrates another flow chart of transmission of low priority data in a talk state of UE, according to some implementations.

FIG. 8 illustrates another example graph of data transmission in a talk state of UE according to some implementations.

FIG. 9 illustrates another flow chart of transmission of low priority data in a talk state of UE, according to some implementations.

FIG. 10 illustrates another example graph of data transmission in a talk state of UE, according to some implementations.

FIG. 11 illustrates another flow chart of transmission of low priority data in a talk state of UE, according to some implementations.

FIG. 12 illustrates another example graph of data transmission in a talk state of UE, according to some implementations.

FIG. 13 illustrates another flow chart of transmission of low priority data in a talk state of UE, according to some implementations.

FIG. 14 illustrates a diagram of an XR system, according to some implementations.

FIG. 15 illustrates an example graph of XR data transmission of a UE, according to some implementations.

FIG. 16 illustrates a flow chart of transmission of low priority data during XR data transmission, according to some implementations.

FIG. 17 illustrates another flow chart of transmission of low priority data during XR data transmission, according to some implementations.

FIG. 18 illustrates an example user equipment (UE), according to some implementations.

FIG. 19 illustrates an example access node, according to some implementations.

### DETAILED DESCRIPTION

This disclosure describes methods and systems for transmission of low priority data (e.g., background data) using configured uplink grants, which are pre-scheduled for transmission of high priority data (e.g., voice data, extended reality (XR) data). In some implementations, the low priority data is split into a plurality of portions, and the plurality of portions are transmitted to a base station, together with the high priority data. In some implementations, the low priority data is delayed waiting for configured uplink grants, so that the low priority data can be transmitted within a packet delay budget using the configured uplink grants. The methods and systems of this disclosure enable a UE to transmit the low priority data using configured uplink grants, instead of using SR or BSR, so that the UE can avoid one extra wakeup due to SR or BSR, resulting in saving power of the UE.

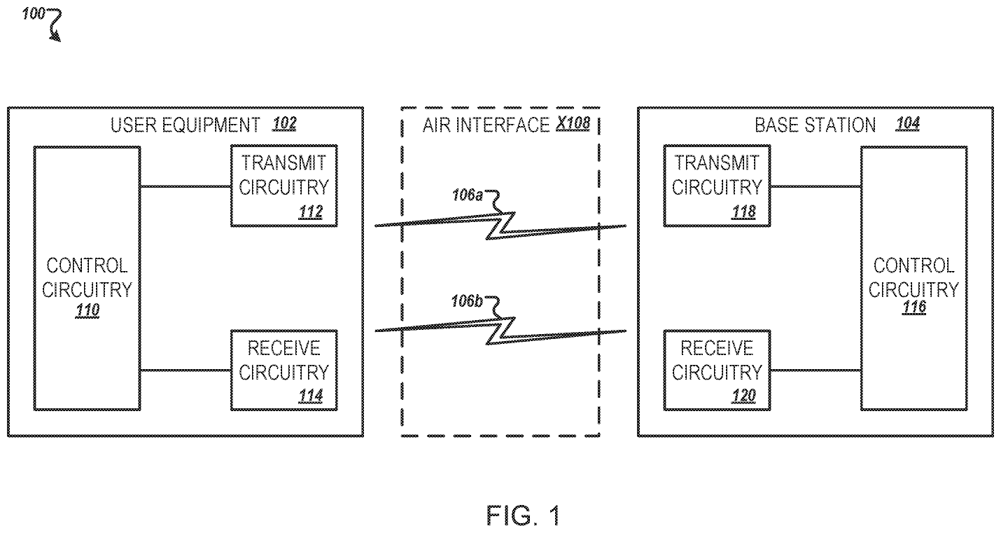

FIG. 1 illustrates an example wireless network, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104. The UE 102 performs transmission of low priority data to the base station 104 using configured uplink grants, which are pre-scheduled for transmission of high priority data.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or an NR-EUTRA Dual Connectivity (NE-DC) network. However, the wireless network 100 may also be a Standalone SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, base station 104 provides the UE 102 network connectivity to a broader network (not shown). This UE 102 connectivity is provided via the air interface 108 in a base station service area provided by base station 104. In some implementations, such a broader network may be a wide area network operated by a cellular network provider, or may be the Internet. Each base station service area associated with base station 104 is supported by antennas integrated with base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “EUTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, an NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a +sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

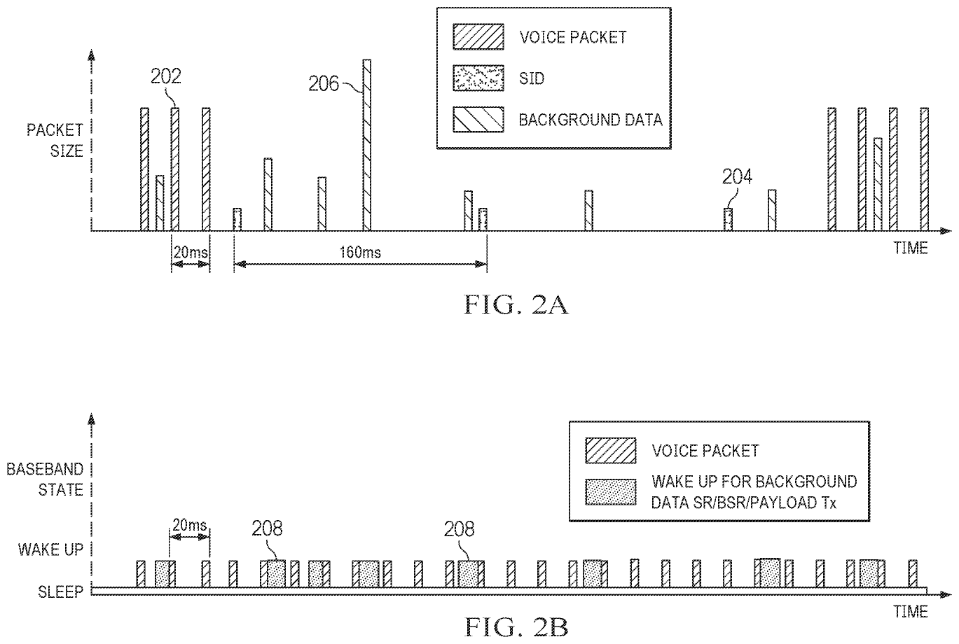

In some implementations, there are two states (a talk state and a silent state) for a user speech in voice over New Radio (VoNR)/Voice over Long-Term Evolution (VoLTE). FIG. 2A illustrates an example graph of data packets of UE, according to some implementations. Referring to FIG. 2A, in a talk state, a voice encoder in user equipment (UE) generates voice packets 202, e.g., every 20 milliseconds (ms). The size of voice packets 202 depends on a coding rate of codecs (encoder-decoder). In a silent state, the UE is silent, and the voice encoder doesn't generate voice packets. Instead, the UE transmits or receives silence insertion descriptor (SID) frames 204, e.g., every 160 ms. Each SID frame can be, e.g., 56 bits for Adaptive Multi-Rate (AMR) speech codecs, or 64 bits for Enhanced Voice Services (EVS) speech codecs.

If VoNR/VoLTE is established, the base station can configure semi-persistently an uplink (UL) grant (pre-scheduling), e.g., every 20 ms, with a resource size large enough for the UE to transmit the voice packets 202. The scheduling mechanism is referred to as Semi-Persistent Scheduling (SPS) in Long-Term Evolution (LTE) or Configured Scheduling (CS) in New Radio (NR).

FIG. 2B illustrates an example graph of baseband states of UE, according to some implementations. In some implementations, referring to FIG. 2B, the base station configures the UE for a short Discontinuous Reception (DRX) cycle, e.g., every 20 ms, so that the UE can enter a sleep mode to save power after waking up every 20 ms (due to SPS or CS) to transmit or receive the voice packets 202. In these implementations, the UE also wakes up every 20 ms in a silent state in case there are voice packets from another UE. If UE has low priority background data of a small size and a low quality of service (QoS) for uplink transmission, the UE has to exit from a sleep mode in a short DRX cycle and wake up frequently to transmit a Scheduling Request (SR) or a Buffer Status Report (BSR) for uplink transmission of the background data. The frequent wakeups consume extra power of UE. The UE may be subject to a call drop due to the extra power consumption when the UE is in a low battery status or in a far cell coverage.

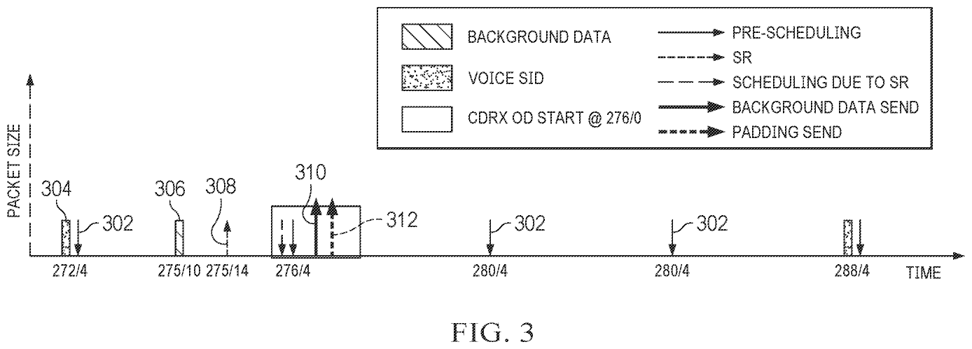

FIG. 3 illustrates another example graph of data packets of UE, according to some implementations. In some implementations, referring to FIG. 3, the UE is in a silent status and generates SID every 160 ms. The base station configures pre-scheduling (SPS or CS, indicated by 302) every 40 ms. After transmitting SID 304 at 272/4 (frame/subframe), the UE enters a sleep mode in a Connected-Mode Discontinuous Reception (CDRX) cycle. The next CDRX on-duration (OD) is anticipated to start at 276/0. However, the background data 306 arrives at 275/10 and the UE wakes up and transmits SR 308 at 275/14, which consumes more power. The disadvantages of this implementation include: 1) UE wakes up 5 ms earlier, which consumes more power; 2) An extra SR 308 is sent at 275/14, which consumes more power; 3) the base station schedules the UE twice, due to SR 308 and pre-scheduling 302. The UE transmits background data (indicated by 310) and padding (indicated by 312) in response to SR 308 and pre-scheduling 302, which wastes power.

### Transmission of Low Priority Data in Silent State

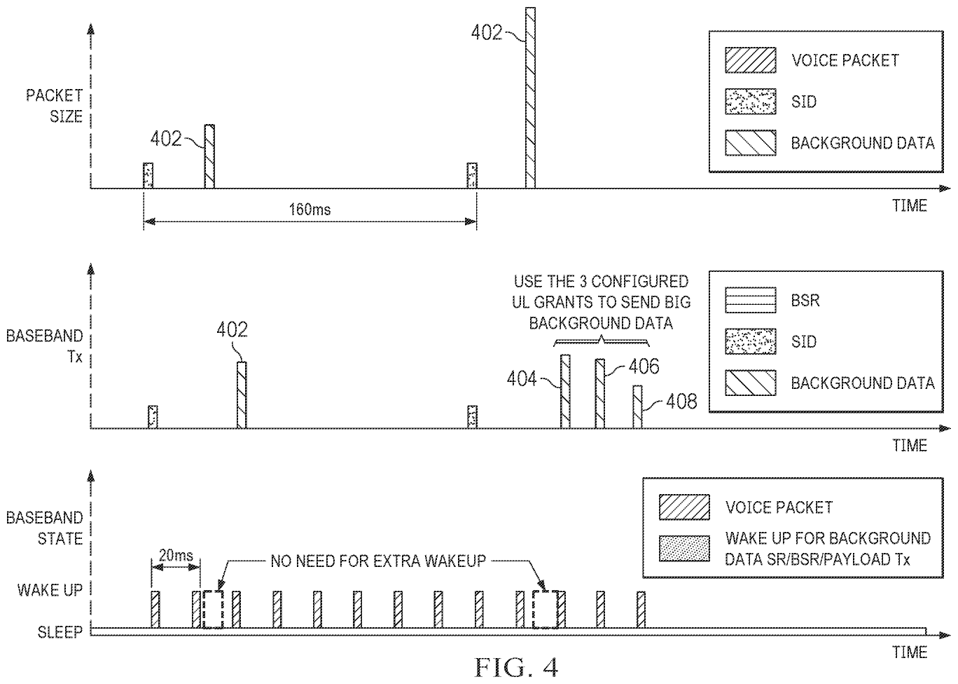

FIG. 4 illustrates another example graph of data transmission in a silent state of UE, according to some implementations. Referring to FIG. 4, in some implementations, low priority data (such as background data 402) of a small size and a low QoS arrives when the UE is in a silent state. The UE transmits the background data 402 to the base station using either a single configured uplink grant or multiple configured uplink grants.

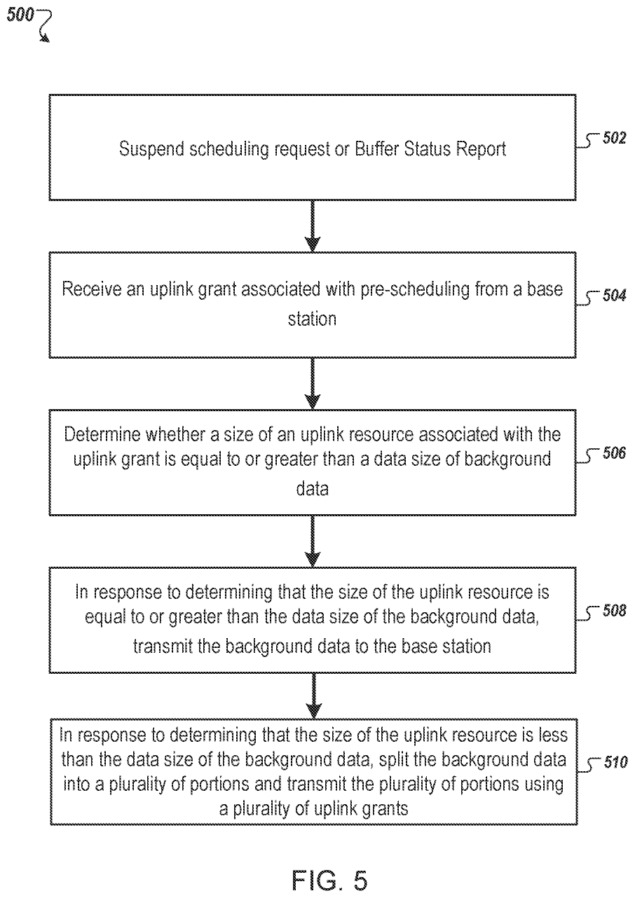

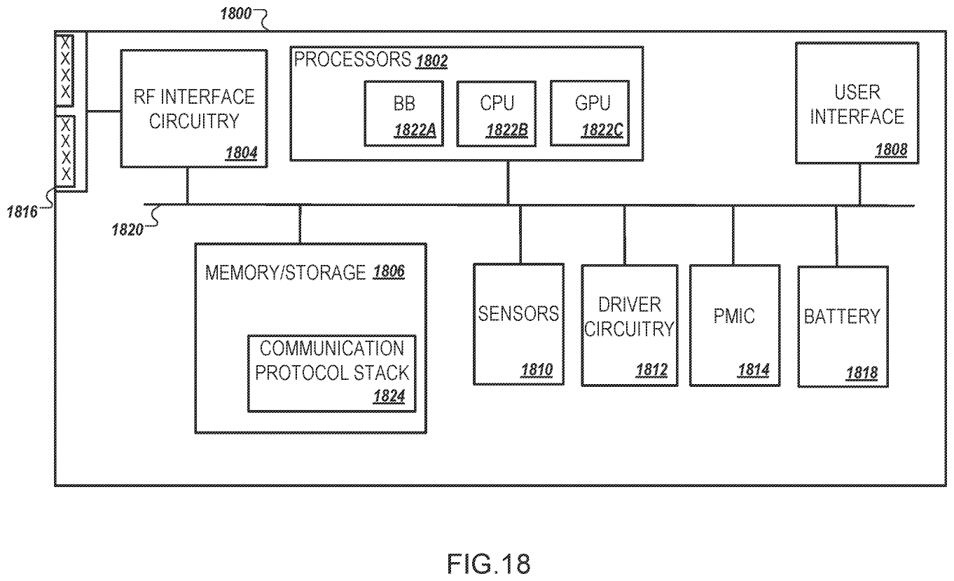

FIG. 5 illustrates a flow chart of transmission of low priority data in a silent state of UE, according to some implementations. The process 500 is described as being performed by UE, such as UE 102 of FIG. 1 or UE 1800 of FIG. 18. The process 500 can be performed in a condition of power status<5% and pathloss>100 dBm; however, the process 500 is not limited to this condition and can be performed in any conditions. The example process 500 shown in FIG. 5 can be modified or reconfigured to include additional, fewer, or different steps (not shown in FIG. 5), which can be performed in the order shown or in a different order.

At 502, the UE suspends SR or BSR to avoid waking up by the background data 402.

At 504, the UE receives an uplink grant associated with pre-scheduling from a base station. A period of the configured uplink grants associated with pre-scheduling is determined by the base station. For example, the configured uplink grant arrives every 5 ms, 10 ms, 20 ms, 40 ms, 80 ms, 160 ms, etc.

At 506, the UE determines whether a size of an uplink resource associated with the uplink grant is equal to or greater than a data size of background data 402. The UE determines whether an uplink resource of a single configured uplink grant is large enough for background data 402.

At 508, in response to determining that the size of the uplink resource is equal to or greater than the data size of the background data 402, the UE transmits the background data 402 to the base station. If the uplink resource of a single configured uplink grant is large enough for background data 402, the UE transmits the background data 402 to the base station using the single configured uplink grant. Instead of transmitting the background data 402 using SR or BSR, the UE transmits the background data 402 using a single configured uplink grant, so that the UE can avoid one extra wakeup due to SR or BSR.

At 510, if the uplink resource of a single configured uplink grant is not large enough for background data 402, for example, the size of the uplink resource of a single configured uplink grant is less than the data size of the background data 402, a plurality of configured uplink grants are used to transmit background data 402. The background data 402 is split into a plurality of portions, e.g., 404, 406, and 408. The three portions 404, 406, and 408 are transmitted to the base station, using three configured uplink grants. The three configured uplink grants can be three consecutive uplink grants (as shown in FIG. 4) or three uplink grants at intervals (not shown). Instead of transmitting the background data 402 using SR or BSR, the UE transmits the background data 402 using a plurality of configured uplink grants, so that the UE can avoid one extra wakeup due to SR or BSR.

### Transmission of Low Priority Data in Talk State

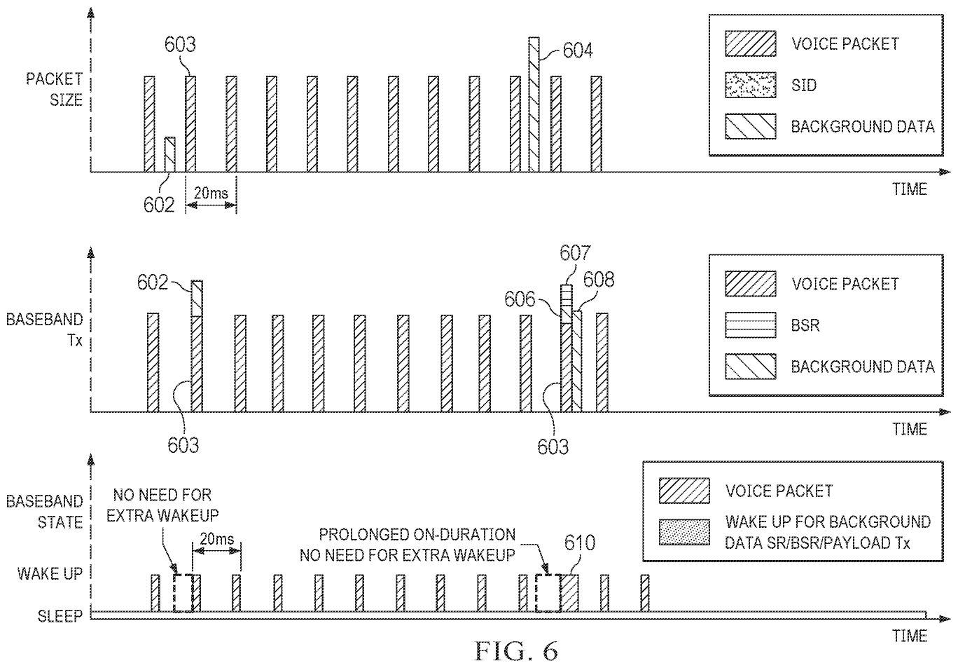

FIG. 6 illustrates another example graph of data transmission in a talk state of UE, according to some implementations. Referring to FIG. 6, in some implementations, low priority background data 602, 604 of a small size and a low QoS arrives when the UE is in a talk state. The UE transmits the background data 602, 604 to the base station together with voice packets 603 using either a single configured uplink grant or a combination of a configured uplink grant and an uplink grant transmitted immediately after the configured uplink grant.

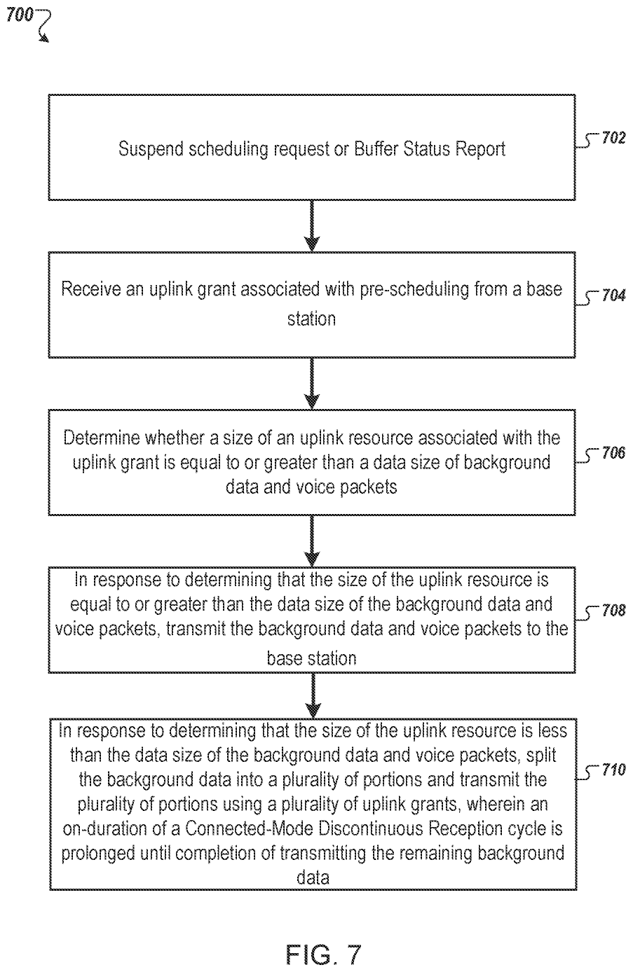

FIG. 7 illustrates another flow chart of transmission of low priority data in a talk state of UE, according to some implementations. The process 700 is described as being performed by UE, such as UE 102 of FIG. 1 or UE 1800 of FIG. 18. The process 700 can be performed in a condition of power status<5% and pathloss>100 dBm; however, the process 700 is not limited to this condition and can be performed in any conditions. The example process 700 shown in FIG. 7 can be modified or reconfigured to include additional, fewer, or different steps (not shown in FIG. 7), which can be performed in the order shown or in a different order.

At 702, the UE suspends SR or BSR to avoid waking up by the low priority data, e.g., background data 602, 604.

At 704, the UE receives an uplink grant associated with pre-scheduling from a base station. A period of the configured uplink grants associated with pre-scheduling is determined by the base station. For example, the configured uplink grant arrives every 5 ms, 10 ms, 20 ms, 40 ms, 80 ms, 160 ms, etc.

At 706, the UE determines whether a size of an uplink resource associated with the uplink grant is equal to or greater than a data size of background data 602, 604 and voice packets 603. The UE determines whether an uplink resource of a single configured uplink grant is large enough for background data 602, 604 and voice packets 603.

At 708, in response to determining that the size of the uplink resource is equal to or greater than the data size of the background data 602 and voice packets 603, the UE transmits the background data 602 and voice packets 603 to the base station. If the uplink resource of a single configured uplink grant is large enough for background data 602 and voice packets 603, the UE transmits the background data 602 and voice packets 603 to the base station using the single configured uplink grant. Instead of transmitting the background data 602 using SR or BSR, the UE transmits the background data 402 together with voice packets 603, using a single configured uplink grant, so that the UE can avoid one extra wakeup due to SR or BSR.

At 710, if the uplink resource of a single configured uplink grant is not large enough for background data 604 and voice packets 603, for example, the size of the uplink resource of a single configured uplink grant is less than the data size of the background data 604 and voice packets 603. The UE transmits a portion of the background data 606 and BSR 607 associated with remaining background data 608 to the base station using a first uplink grant. The base station transmits a second uplink grant immediately to the UE after receiving the portion of the background data 606 and the BSR 607 associated with remaining background data. Upon receiving the second uplink grant, the UE transmits the remaining background data 608 corresponding to the BSR 607 to the base station. Instead of transmitting the background data 606 and 608 using two SRs or BSRs, the UE transmits the background data 606 and 608 using a configured uplink grant and another uplink grant transmitted immediately after the configured uplink grant by the base station. During transmission of the background data 606 and 608, an on-duration of a Connected-Mode Discontinuous Reception (CDRX) cycle 610 is prolonged until completion of transmitting the remaining background data 608, so that the UE can avoid one extra wakeup due to SR or BSR.

In some implementations, the low priority data, such as web browsing, email fetching, or background data (e.g., Applications executed on UE), etc., can be transmitted using a process as illustrated in FIG. 5 or FIG. 7. However, high priority data, such as VoLTE, VoNR, FaceTime Video, or extended reality (XR) Video/Voice, etc., is transmitted using an uplink grant scheduled by SR or BSR without any delay. The priority can be determined based on 5G QoS Identifier (5QI). For example, traffic data indicated by Guaranteed Bit Rate (GBR) 5QI 1-4 is high priority data. Traffic data indicated by Non-GBR 5QI 5-9 is low priority data. The process 500 or 700 as illustrated in FIG. 5 or FIG. 7 can be applied to massive machine-type communications (mMTC) involving configured uplink grants for video/audio data.

### Transmission of Low Priority Data Based on QoS Delay Budget

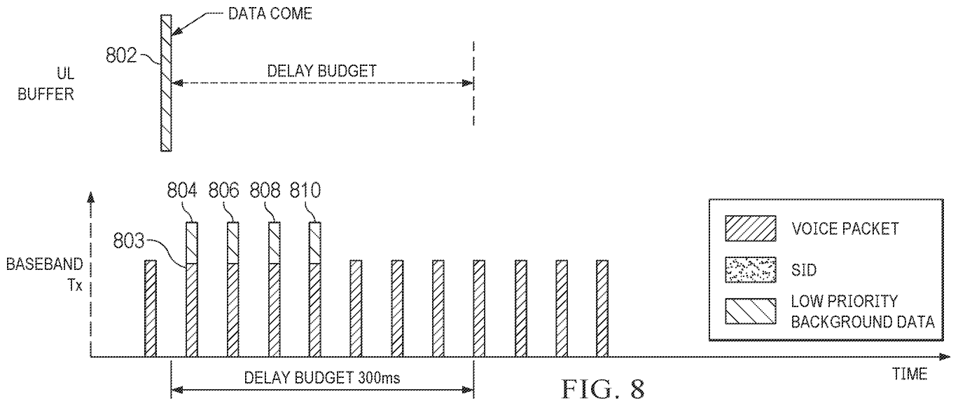

FIG. 8 illustrates another example graph of data transmission in a talk state of UE, according to some implementations. Referring to FIG. 8, in some implementations, low priority background data 802 of a small size and a low QoS arrives when the UE is in a talk state. The UE transmits the background data 802 to the base station together with voice packets 803 using multiple configured uplink grants within a predetermined Packet Delay Budget (PDB).

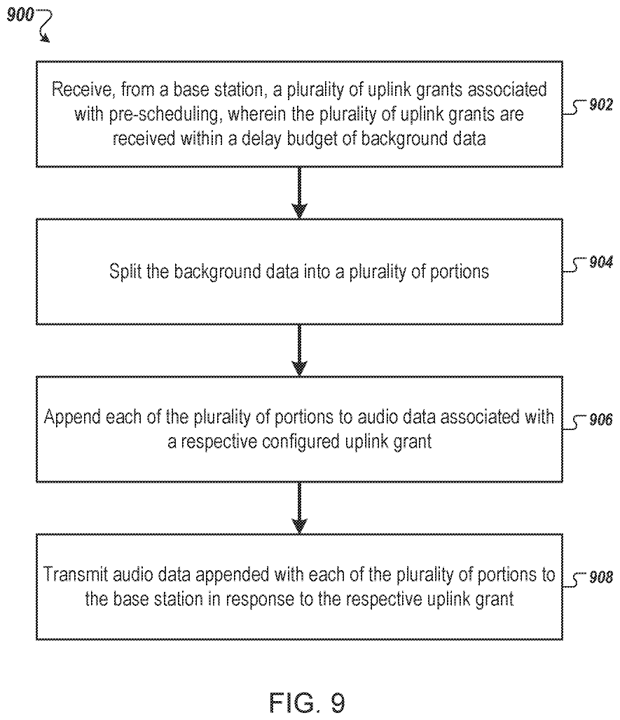

FIG. 9 illustrates another flow chart of transmission of low priority data in a talk state of UE, according to some implementations. The process 900 is described as being performed by UE, such as UE 102 of FIG. 1 or UE 1800 of FIG. 18. The process 900 can be performed in a condition of power status<5% and pathloss>100 dBm; however, the process 900 is not limited to this condition and can be performed in any conditions. The example process 900 shown in FIG. 9 can be modified or reconfigured to include additional, fewer, or different steps (not shown in FIG. 9), which can be performed in the order shown or in a different order.

At 902, the UE receives background data 802 and a plurality of uplink grants associated with pre-scheduling from a base station. The plurality of uplink grants are received within a delay budget of background data 802. A period of the configured uplink grants associated with pre-scheduling is determined by the base station. For example, the configured uplink grant arrives every 5 ms, 10 ms, 20 ms, 40 ms, 80 ms, 160 ms, etc.

At 904, the UE splits the background data 802 into a plurality of portions 804, 806, 808, 810. The size of each portion 804, 806, 808, 810 can be the same or different. The size of each portion 804, 806, 808, 810 and voice packets 803 is equal to or less than an uplink resource size of each configured uplink grant.

At 906, the UE appends each portion 804, 806, 808, 810 to voice packets 803 (audio data) associated with a respective configured uplink grant.

At 908, the UE transmits voice packets 803 appended with each portion 804, 806, 808, 810 to the base station using a plurality of consecutive configured uplink grants (e.g., four consecutive configured uplink grants as shown in FIG. 8)

In some implementations, high priority data is subject to no delay. Low priority data can be subject to a predetermined PDB. The PDB can be predetermined according to Table 5.7.4-1 of 3rd Generation Partnership Project (3GPP) Technical Specification (TS) 23.501. For example, web browsing can be subject to 300 ms PDB. The maximum CDRX cycles (MaxCycle) that can be delayed is calculated using Equation (1) below.

$$MaxCycle = Packet Delay Budget / CDRX period \qquad ( 1 )$$

For example, low priority data only includes traffic data from a single application, e.g., web browsing, which is subject to 300 ms PDB. The period of CDRX cycles (pre-scheduling) is, e.g., 40 ms. MaxCycle of web browsing is 300 ms/40 ms=7.5 cycles. Thus, an SR request for transmitting web browsing data can be delayed with 7 CDRX cycles.

For example, low priority data only includes traffic data from multiple applications, e.g., web browsing and interactive gaming. The web browsing is subject to 300 ms PDB, while the interactive gaming is subject to 100 ms PDB. The period of CDRX cycles (pre-scheduling) is, e.g., 40 ms. MaxCycle of web browsing is 300 ms/40 ms=7.5 cycles, while MaxCycle of interactive gaming is 100 ms/40 ms=2.5 cycles. Maxcyle for both applications=Min (Application Type 1, Application Type 2)=Min (7.5, 2.5)=2.5 cycles. Thus, an SR request for transmitting web browsing data and interactive gaming data can be delayed with 2 CDRX cycles.

Transmission of Low Priority Data with High Priority Data

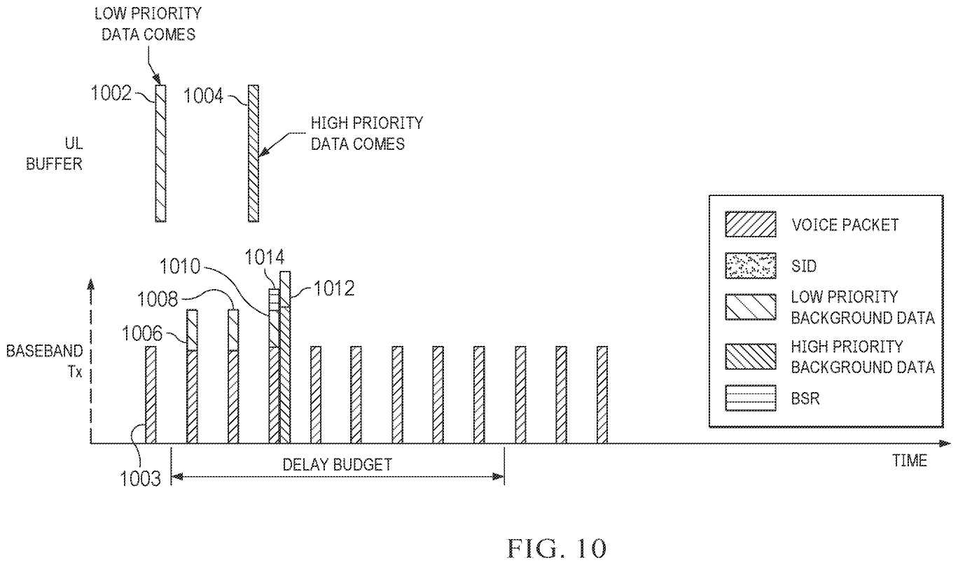

FIG. 10 illustrates another example graph of data transmission in a talk state of UE, according to some implementations. Referring to FIG. 10, in some implementations, low priority background data 1002 of a small size and a low QoS and high priority background data 1004 arrive when the UE is in a talk state. The UE transmits a portion of low priority background data 1002 to the base station together with high priority background data 1004 within a predetermined PDB.

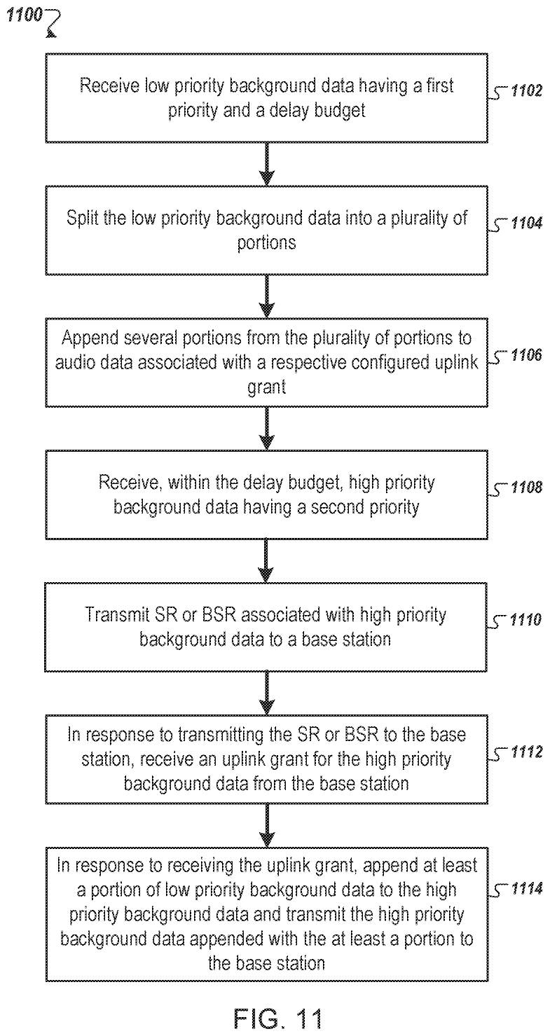

FIG. 11 illustrates another flow chart of transmission of low priority data in a talk state of UE, according to some implementations. The process 1100 is described as being performed by UE, such as UE 102 of FIG. 1 or UE 1800 of FIG. 18. The process 1100 can be performed in a condition of power status<5% and pathloss>100 dBm; however, the process 1100 is not limited to this condition and can be performed in any conditions. The example process 1100 shown in FIG. 11 can be modified or reconfigured to include additional, fewer, or different steps (not shown in FIG. 11), which can be performed in the order shown or in a different order.

At 1102, the UE receives low priority background data 1002 having a first priority and a delay budget (e.g., PDB). The low priority background data 1002 is delay tolerant.

At 1104, the UE splits low priority background data 1002 into a plurality of portions 1006, 1008, 1010, 1012. An uplink resource size of a configured uplink grant is not large enough to accommodate all the low priority background data 1002, and thus the low priority background data 1002 is split into a plurality of portions 1006, 1008, 1010, 1012, so that the size of voice packets 1003 and each portion is less than or equal to the uplink resource size of a configured uplink grant. The plurality of portions 1006, 1008, 1010, 1012 can have the same size, or different sizes.

At 1106, the UE appends portions 1006, 1008, 1010 to audio data (e.g., voice packets 1003) associated with a respective configured uplink grant. The portions 1006, 1008, 1010 are appended to voice packets 1003 in three consecutive configured uplink grants.

At 1108, the UE receives, within the delay budget, high priority background data 1004 having a second priority. The first priority is lower than the second priority. As shown in FIG. 10, the high priority background data 1004 arrives between transmitting the portion 1008 and the portion 1010.

At 1110, the UE transmits SR or BSR associated with high priority background data 1004 to a base station. In some implementations, as shown in FIG. 10, BSR 1014 associated with high priority background data 1004 is transmitted together with voice packets 1003 and portion 1010.

At 1112, in response to transmitting the SR or BSR to the base station, the UE receives an uplink grant for the high priority background data 1004 from the base station.

At 1114, in response to receiving the uplink grant, the UE appends at least a portion of low priority background data 1002, e.g., portion 1012, to the high priority background data 1004 and transmits the high priority background data 1004 appended with portion 1012 to the base station.

### Transmission of Low Priority Data Before Delay Budget Expires

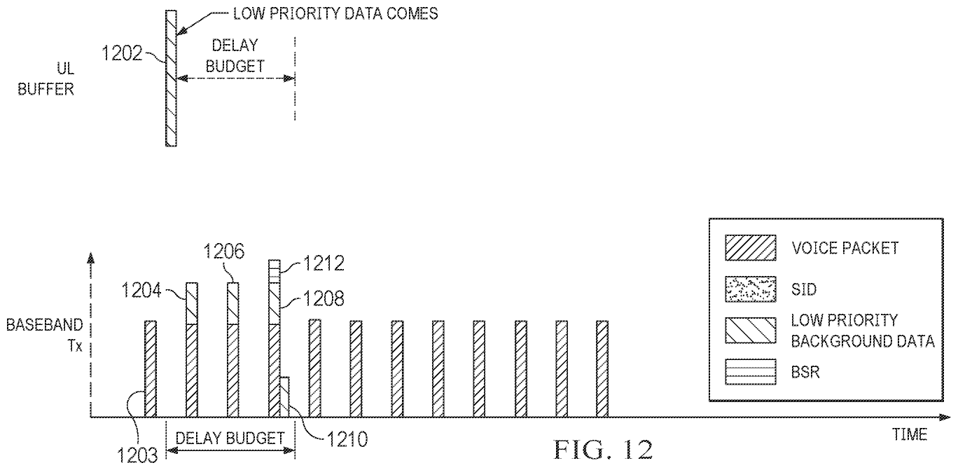

FIG. 12 illustrates another example graph of data transmission in a talk state of UE, according to some implementations. Referring to FIG. 12, in some implementations, low priority background data 1202 of a small size and a low QoS arrives when the UE is in a talk state. The UE transmits a portion of low priority background data 1202 immediately before expiration of PDB.

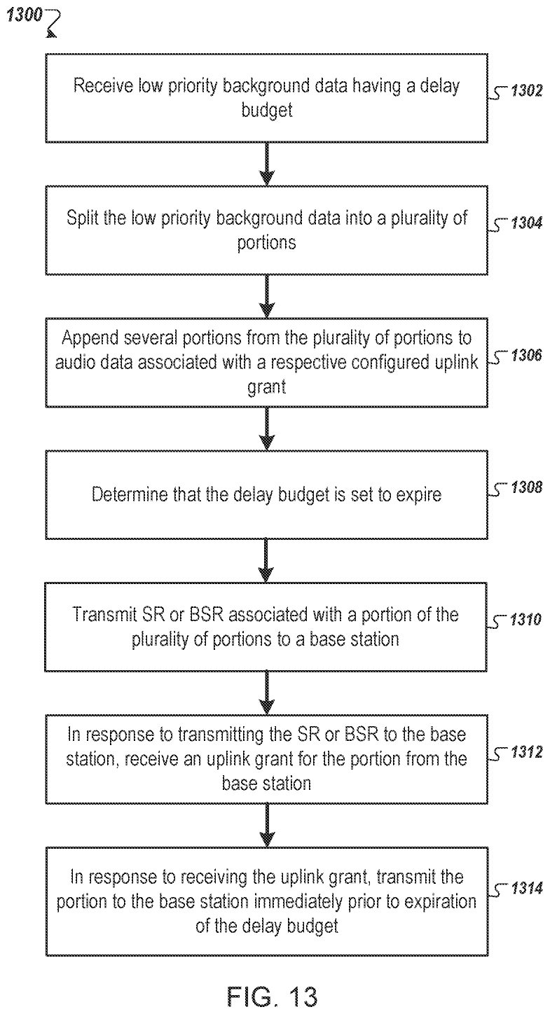

FIG. 13 illustrates another flow chart of transmission of low priority data in a talk state of UE, according to some implementations. The process 1300 is described as being performed by UE, such as UE 102 of FIG. 1 or UE 1800 of FIG. 18. The process 1300 can be performed in a condition of power status<5% and pathloss>100 dBm; however, the process 1300 is not limited to this condition and can be performed in any conditions. The example process 1300 shown in FIG. 13 can be modified or reconfigured to include additional, fewer, or different steps (not shown in FIG. 13), which can be performed in the order shown or in a different order.

At 1302, the UE receives low priority background data 1202 having a delay budget (e.g., PDB). The low priority background data 1202 is delay tolerant.

At 1304, the UE splits low priority background data 1202 into a plurality of portions 1204, 1206, 1208, 1210. An uplink resource size of a configured uplink grant is not large enough to accommodate all the low priority background data 1202, and thus the low priority background data 1202 is split into a plurality of portions 1204, 1206, 1208, 1210, so that the size of voice packets 1203 and each portion is less than or equal to the uplink resource size of a configured uplink grant. The plurality of portions 1204, 1206, 1208, 1210 can have the same size, or different sizes.

At 1306, the UE appends portions 1204, 1206, 1208 to audio data (e.g., voice packets 1203) associated with a respective configured uplink grant. The portions 1204, 1206, 1208 are appended to voice packets 1203 in three consecutive configured uplink grants.

At 1308, the UE determines that the delay budget is set to expire. For example, the remaining delay budget is less than a predetermined threshold value, e.g., 10 ms. However, the portion 1210 has not been transmitted to the base station yet, and the next configured uplink grant is anticipated to arrive after the expiration of the delay budget.

At 1310, in response to determination that the delay budget is set to expire, the UE transmits SR or BSR associated with the portion 1210 to the base station. In some implementations, as shown in FIG. 12, BSR 1212 is transmitted together with voice packets 1203 and portion 1208.

At 1312, in response to transmitting the SR or BSR to the base station, the UE receives an uplink grant for the portion 1210 from the base station.

At 1314, in response to receiving the uplink grant associated with the SR or BSR, the UE transmits the portion 1210 to the base station immediately prior to the expiration of the delay budget.

### Transmission of Low Priority Data in Extended Reality (XR) Applications

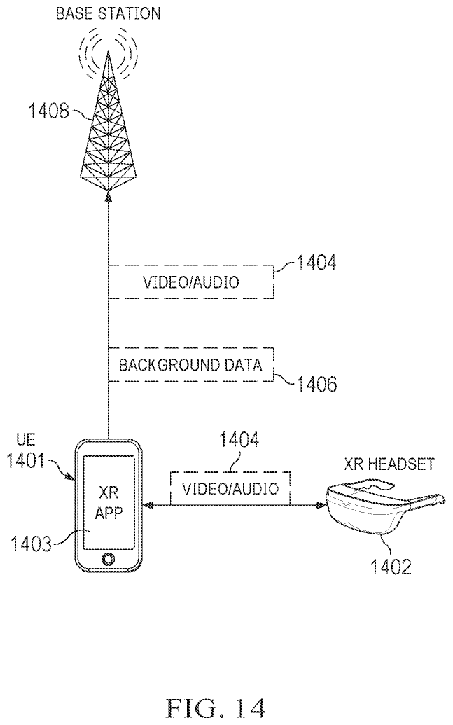

FIG. 14 illustrates a diagram of an XR system, according to some implementations. As shown in FIG. 14, the XR headset 1402 is connected to UE 1401, which transmits XR data (video/audio data) 1404 and background data 1406 to the base station 1408. Background data 1406 relates to the use of multiple Applications (Apps) installed and executed on the UE 1401 when Apps are not in active use. The Apps constantly update themselves in the background with the newest information and content. Background data 1406 is also referred to as background App refresh. One or more XR Apps 1403 for controlling the XR headset 1402 are installed and executed on the UE 1401. In some implementations, the UE 1401 and the XR headset 1402 can be integrated into a single device.

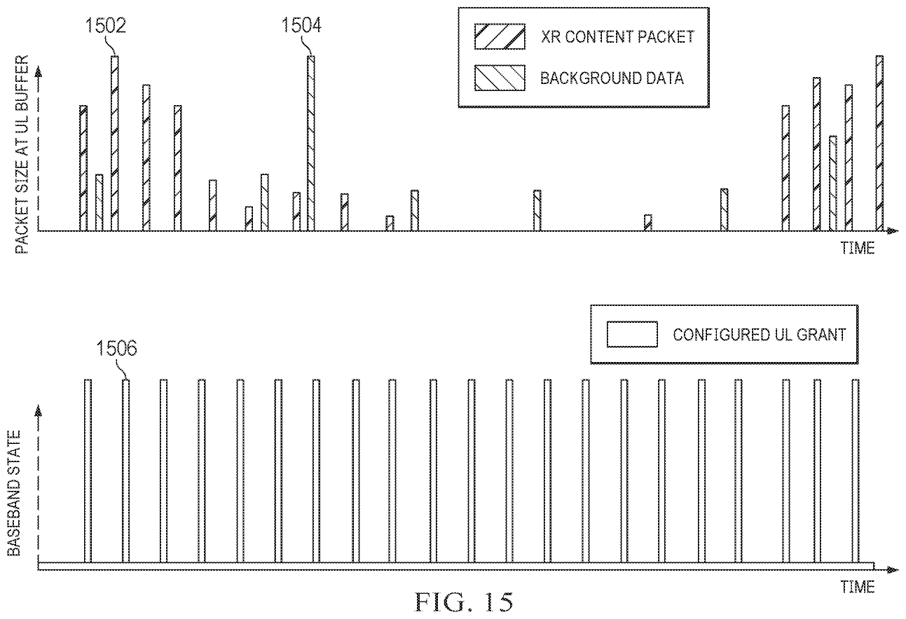

FIG. 15 illustrates an example graph of XR data transmission of a UE, according to some implementations. Referring to FIGS. 14 and 15, in some implementations, low priority background data 1406 or 1504 of a small size and a low QoS arrives when the UE 1401 is transmitting XR data 1404 or 1502 to the base station 1408.

The base station 1408 configures the UE 1401 with configured uplink grants for interactive XR applications 1403, so that the UE 1401 can transmit the XR data 1404 or 1502 with a better data resolution and less jitter.

The video packet sizes vary upon user activities. For example, when a user wearing the XR headset 1402 is transmitting camera videos to the UE 1401, the video packet size varies as the user moves. The video packet size increases as the user moves faster, while the video packet size decreases as the user moves slower. The video packets are generated less frequently as the user is still. As shown in FIG. 15, XR data packets 1502 vary with time. XR data packets 1502 and background data 1504 arrive at an uplink buffer of the UE 1401. Uplink resources of the configured uplink grants 1506 are available for the baseband of the UE 1401 to perform uplink data transmission.

In some implementations, upon arrival of uplink data at an uplink buffer, a traffic priority of the uplink data is determined. For example, web browsing, email fetching, and background data having a non-critical traffic class are of a low priority, while VoLTE, VoNR, FaceTime Video, and XR Video/Voice, etc. having a critical traffic class are of a high priority. If the uplink data (e.g., 1504) is determined to have a low priority, an arrival timestamp is marked for the low priority uplink data 1504 for calculation of a remaining delay budget. A delay budget PDB of the low priority uplink data 1504 is determined according to Table 5.7.4-1 of 3GPP TS 23.501.

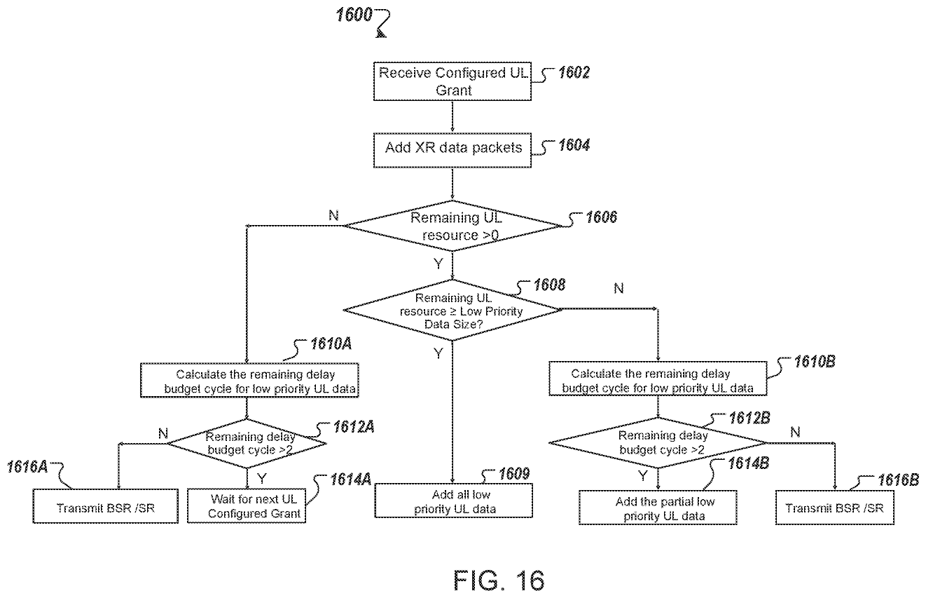

FIG. 16 illustrates a flow chart of transmission of low priority data during XR data transmission, according to some implementations. The process 1600 is described as being performed by UE, such as UE 102 of FIG. 1 or UE 1800 of FIG. 18. The process 1600 can be performed in a condition of power status<5% and pathloss>100 dBm; however, the process 1600 is not limited to this condition and can be performed in any conditions. The example process 1600 shown in FIG. 16 can be modified or reconfigured to include additional, fewer, or different steps (not shown in FIG. 16), which can be performed in the order shown or in a different order.

At 1602, UE 1401 receives a configured uplink grant associated with pre-scheduling, e.g., every 40 ms, from the base station 1408.

At 1604, UE 1401 adds XR data packets 1502 into an uplink resource associated with the configured uplink grant. In some implementations, UE 1401 additionally adds Medium Access Control (MAC) Control Element (CE)/Radio Link Control (RLC) control Protocol Data Unit (PDU) into the uplink resource associated with the configured uplink grant. The status of RLC control PDU is indicated by Status PDU. As described in 38.322 6.1.3, Status PDU is used by the receiving side of an AM RLC entity to inform the peer AM RLC entity about RLC data PDUs that are received successfully, and RLC data PDUs that are detected to be lost by the receiving side of an AM RLC entity. As described in 38.321 6.1.3, MAC uplink CE is used for reporting UE's buffer status/power headroom, etc., to the network. BSR is a type of MAC CE according to 3GPP 38.321 6.1.3.1.

At 1606, UE 1401 determines whether there is a remaining uplink resource (a size of the remaining uplink resource is greater than zero) associated with the configured uplink grant. Remaining uplink resource=Size of uplink resource of a configured uplink grant−XR data packets size−MAC CE/RLC control PDU.

At 1608, UE 1401 determines whether the size of the remaining uplink resource is equal to or greater than a size of low priority background data 1504.

At 1609, if the size of the remaining uplink resource is equal to or greater than the size of low priority background data 1504, UE 1401 adds all the low priority background data 1504 into the uplink resource associated with the configured uplink grant.

At 1610B, if the size of the remaining uplink resource is less than the size of low priority background data 1504, UE 1401 calculates remaining delay budget cycles for the low priority background data 1504. The remaining delay budget cycles are calculated using Equation (2) below.

$$Remaining Delay Budget Cycles = ( PDB - ( current time - packet arrival time ) ) / CDRX period \qquad ( 2 )$$

At 1612B, UE 1401 determines whether a remaining delay budget is greater than a predetermined threshold value. For example, UE 1401 determines whether remaining delay budget cycles are greater than 2 cycles.

At 1614B, if the remaining delay budget cycles are greater than 2 cycles, UE 1401 adds a portion of the low priority background data 1504 into the remaining uplink resource. The size of the portion of the low priority background data 1504 is equal to or less than the size of the remaining uplink resource.

At 1616B, if the remaining delay budget cycles are less than or equal to 2 cycles and the PDB is set to expire, UE 1401 transmits SR/BSR to request a new uplink grant for transmission of low priority background data 1504 prior to expiration of PDB.

At 1610A, if there is no remaining uplink resource (a size of the remaining uplink resource is equal to zero) associated with the configured uplink grant, similarly to 1610B, UE 1401 calculates remaining delay budget cycles for the low priority background data 1504. The remaining delay budget cycles are calculated using Equation (2).

At 1612A, similarly to 1612B, UE 1401 determines whether remaining delay budget is greater than a predetermined threshold value. For example, UE 1401 determines whether remaining delay budget cycles are greater than 2 cycles.

At 1614A, if the remaining delay budget cycles are greater than 2 cycles, UE 1401 waits for the next configured UL grant for transmission of low priority background data 1504.

At 1616A, similarly to 1616B, if the remaining delay budget cycles are less than or equal to 2 cycles and the PDB is set to expire, UE 1401 transmits SR/BSR to request a new uplink grant for transmission of low priority background data 1504 prior to expiration of PDB.

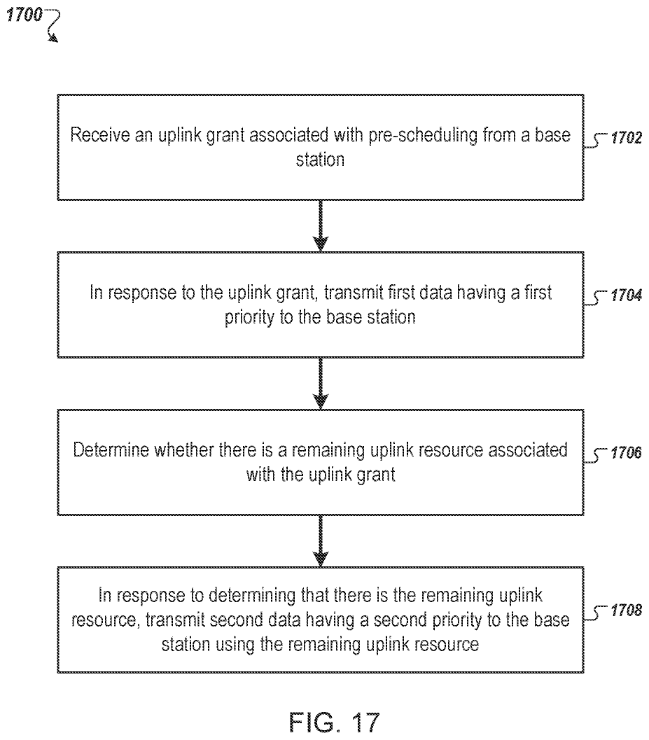

FIG. 17 illustrates another flow chart of transmission of low priority data during XR data transmission, according to some implementations. The process 1700 is described as being performed by UE, such as UE 102 of FIG. 1 or UE 1800 of FIG. 18. The process 1700 can be performed in a condition of power status<5% and pathloss>100 dBm; however, the process 1300 is not limited to this condition and can be performed in any conditions. The example process 1700 shown in FIG. 17 can be modified or reconfigured to include additional, fewer, or different steps (not shown in FIG. 17), which can be performed in the order shown or in a different order.

At 1702, UE 1401 receives a configured uplink grant associated with pre-scheduling from base station 1408.

At 1704, in response to the configured uplink grant, UE 1401 transmits first data having a first priority, e.g., high priority XR data 1404 or 1502, to the base station 1408.

At 1706, UE 1401 determines whether there is a remaining uplink resource associated with the configured uplink grant.

At 1708, in response to determining that there is the remaining uplink resource, UE 1401 transmits second data having a second priority, e.g., low priority background data 1406 or 1504, to the base station 1408, using the remaining uplink resource. The second priority is lower than the first priority.

FIG. 18 is a block diagram of an example UE, according to some implementations. The UE 1800 may be similar to and substantially interchangeable with UE 102 of FIG. 1.

The UE 1800 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smartwatch), relaxed-IoT devices.

The UE 1800 may include processors 1802, RF interface circuitry 1804, memory/storage 1806, user interface 1808, sensors 1810, driver circuitry 1812, power management integrated circuit (PMIC) 1814, antenna structure 1816, and battery 1818. The components of the UE 1800 may be implemented as integrated circuits (ICs), portions thereof, discrete electronic devices, or other modules, logic, hardware, software, firmware, or a combination thereof. The block diagram of FIG. 18 is intended to show a high-level view of some of the components of the UE 1800. However, some of the components shown may be omitted, additional components may be present, and different arrangements of the components shown may occur in other implementations.

The components of the UE 1800 may be coupled with various other components over one or more interconnects 1820, which may represent any type of interface, input/output, bus (local, system, or expansion), transmission line, trace, optical connection, etc. that allows various circuit components (on common or different chips or chipsets) to interact with one another.

The processors 1802 may include processor circuitry such as, for example, baseband processor circuitry (BB) 1822A, central processor unit circuitry (CPU) 1822B, and graphics processor unit circuitry (GPU) 1822C. The processors 1802 may include any type of circuitry or processor circuitry that executes or otherwise operates computer-executable instructions, such as program code, software modules, or functional processes from memory/storage 1806 to cause the UE 1800 to perform operations as described herein.

In some implementations, the baseband processor circuitry 1822A may access a communication protocol stack 1824 in the memory/storage 1806 to communicate over a 3GPP compatible network. In general, the baseband processor circuitry 1822A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1804. The baseband processor circuitry 1822A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 1806 may include one or more non-transitory, computer-readable media that includes instructions (for example, communication protocol stack 1824) that may be executed by one or more of the processors 1802 to cause the UE 1800 to perform various operations described herein. The memory/storage 1806 includes any type of volatile or non-volatile memory that may be distributed throughout the UE 1800. In some implementations, some of the memory/storage 1806 may be located on the processors 1802 themselves (for example, L1 and L2 cache), while other memory/storage 1806 is external to the processors 1802 but accessible thereto via a memory interface. The memory/storage 1806 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1804 may include transceiver circuitry and radio frequency front module (RFEM) that allows the UE 1800 to communicate with other devices over a radio access network. The RF interface circuitry 1804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1816 and proceed to filter and amplify (with a low-noise amplifier) the signal. The signal may be provided to a receiver of the transceiver that downconverts the RF signal into a baseband signal that is provided to the baseband processor of the processors 1802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1816.

In various implementations, the RF interface circuitry 1804 may be configured to transmit/receive signals in a manner compatible with NR access technologies.

The antenna 1816 may include antenna elements to convert electrical signals into radio waves to travel through the air and convert received radio waves into electrical signals. The antenna elements may be arranged into one or more antenna panels. The antenna 1816 may have antenna panels that are omnidirectional, directional, or a combination thereof to enable beamforming and multiple input, multiple output communications. The antenna 1816 may include microstrip antennas, printed antennas fabricated on the surface of one or more printed circuit boards, patch antennas, phased array antennas, etc. The antenna 1816 may have one or more panels designed for specific frequency bands including bands in FRI or FR2.

The user interface 1808 includes various input/output (I/O) devices designed to enable user interaction with the UE 1800. The user interface 1808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1800.

The sensors 1810 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1812 may include software and hardware elements that operate to control particular devices that are embedded in the UE 1800, attached to the UE 1800, or otherwise communicatively coupled with the UE 1800. The driver circuitry 1812 may include individual drivers allowing other components to interact with or control various input/output (I/O) devices that may be present within, or connected to, the UE 1800. For example, driver circuitry 1812 may include a display driver to control and allow access to a display device, a touchscreen driver to control and allow access to a touchscreen interface, sensor drivers to obtain sensor readings of sensor circuitry 1810 and control and allow access to sensor circuitry 1810, drivers to obtain actuator positions of electro-mechanic components or control and allow access to the electro-mechanic components, a camera driver to control and allow access to an embedded image capture device, audio drivers to control and allow access to one or more audio devices.

The PMIC 1814 may manage power provided to various components of the UE 1800. In particular, with respect to the processors 1802, the PMIC 1814 may control power-source selection, voltage scaling, battery charging, or DC-to-DC conversion.

In some implementations, the PMIC 1814 may control, or otherwise be part of, various power saving mechanisms of the UE 1800 including DRX as discussed herein. A battery 1818 may power the UE 1800, although in some examples the UE 1800 may be mounted or deployed in a fixed location, and may have a power supply coupled to an electrical grid. The battery 1818 may be a lithium-ion battery, a metal-air battery, such as a zinc-air battery, an aluminum-air battery, a lithium-air battery, and the like. In some implementations, such as in vehicle-based applications, the battery 1818 may be a typical lead-acid automotive battery.

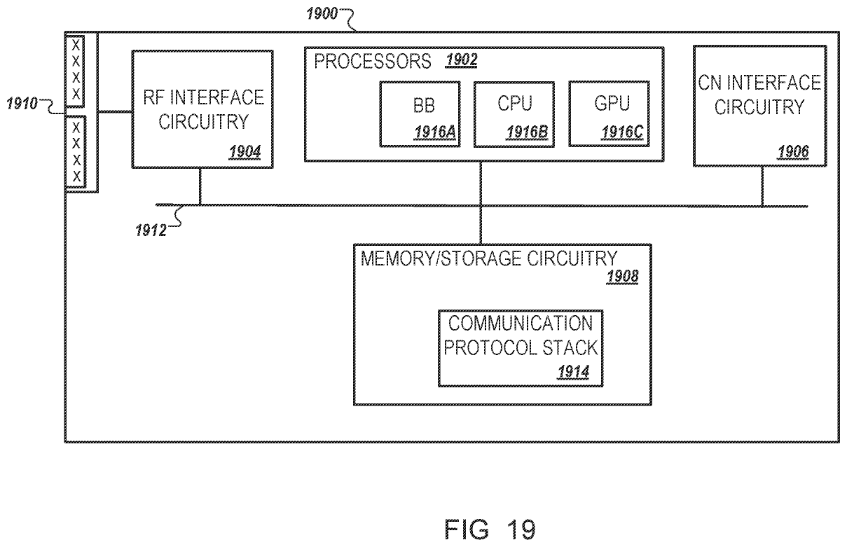

FIG. 19 is a block diagram of an example access node, according to some implementations. FIG. 19 illustrates an access node 1900 (e.g., a base station or gNB), in accordance with some implementations. The access node 1900 may be similar to and substantially interchangeable with the base station 104 of FIG. 1. The access node 1900 may include processors 1902, RF interface circuitry 1904, core network (CN) interface circuitry 1906, memory/storage circuitry 1908, and antenna structure 1910.

The components of the access node 1900 may be coupled with various other components over one or more interconnects 1912. The processors 1902, RF interface circuitry 1904, memory/storage circuitry 1908 (including communication protocol stack 1914), antenna structure 1910, and interconnects 1912 may be similar to like-named elements shown and described with respect to FIG. 18. For example, the processors 1902 may include processor circuitry such as, for example, baseband processor circuitry (BB) 1916A, central processor unit circuitry (CPU) 1916B, and graphics processor unit circuitry (GPU) 1916C.

The CN interface circuitry 1906 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 1900 via a fiber optic or wireless backhaul. The CN interface circuitry 1906 may include one or more dedicated processors or FPGAs to communicate using one or more of the aforementioned protocols. In some implementations, the CN interface circuitry 1906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1900 that operates in an NR or 5G system (for example, a gNB), and the term “E-UTRAN node” or the like may refer to an access node 1900 that operates in an LTE or 4G system (e.g., an eNB). According to various implementations, the access node 1900 may be implemented as one or more of a dedicated physical device such as a macrocell base station, and/or a low power (LP) base station for providing femtocells, picocells, or other like cells having smaller coverage areas, smaller user capacity, or higher bandwidth compared to macrocells.

In some implementations, all or parts of the access node 1900 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1900; a MAC/PHY split wherein RRC, PDCP, RLC, and MAC layers are operated by the CRAN/vBBUP and the PHY layer is operated by the access node 1900; or a “lower PHY” split wherein RRC, PDCP, RLC, MAC layers and upper portions of the PHY layer are operated by the CRAN/vBBUP and lower portions of the PHY layer are operated by the access node 1900.

In V2X scenarios, the access node 1900 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. One or more processors of a user equipment (UE), the one or more processors configured to cause the UE to perform operations comprising:
receiving an uplink grant associated with pre-scheduling from a base station;
in response to the uplink grant, transmitting first data having a first priority to the base station;
determining whether there is a remaining uplink resource associated with the uplink grant; and
in response to determining that there is the remaining uplink resource, transmitting second data having a second priority to the base station using the remaining uplink resource, wherein the second priority is lower than the first priority.

2. The one or more processors of claim 1, the operations further comprising:
in response to determining that there is no remaining uplink resource,
receiving, from the base station, at least one subsequent uplink grant associated with the pre-scheduling; and
in response to receiving the at least one subsequent uplink grant, transmitting the second data to the base station.

3. The one or more processors of claim 1, the operations further comprising:
in response to determining that there is no remaining uplink resource,
transmitting a scheduling request (SR) or a Buffer Status Report (BSR) to the base station;
in response to transmitting the SR or the BSR to the base station, receiving a second uplink grant; and
in response to receiving the second uplink grant, transmitting the second data to the base station.

4. The one or more processors of claim 1, the operations further comprising:
determining whether a size of the remaining uplink resource is greater than a data size of the second data; and
in response to determining that the size of the remaining uplink resource is greater than the data size of the second data, transmitting the second data to the base station.

5. The one or more processors of claim 4, the operations further comprising:
in response to determining that the size of the remaining uplink resource is equal to or less than the data size of the second data, transmitting a portion of the second data to the base station, wherein a data size of the portion of the second data is equal to or less than the size of the remaining uplink resource.

6. The one or more processors of claim 5, transmitting the portion of the second data further comprising:
determining remaining delay budget cycles for the second data;
determining that the remaining delay budget cycles are greater than a predetermined number of Connected-Mode Discontinuous Reception (CDRX) cycles;
in response to determining that the remaining delay budget cycles are greater than the predetermined number of CDRX cycles, transmitting the portion of the second data to the base station.

7. The one or more processors of claim 6, wherein the remaining delay budget cycles=(a delay budget of the second data−(current time point−arrival time point of the second data))/duration of a CDRX cycle.

8. The one or more processors of claim 4, the operations further comprising:
in response to determining that the size of the remaining uplink resource is equal to or less than the data size of the second data,
transmitting a scheduling request (SR) or a Buffer Status Report (BSR) to the base station;
in response to transmitting the SR or the BSR to the base station, receiving a second uplink grant; and
in response to receiving the second uplink grant, transmitting the second data to the base station.

9. The one or more processors of claim 8, transmitting the second data further comprising:
determining remaining delay budget cycles for the second data;
determining that the remaining delay budget cycles are greater than a predetermined number of Connected-Mode Discontinuous Reception (CDRX) cycles;
in response to determining that the remaining delay budget cycles are greater than the predetermined number of CDRX cycles, transmitting the second data to the base station.

10. The one or more processors of claim 9, wherein the remaining delay budget cycles=(a delay budget of the second data−(current time point−arrival time point of the second data))/duration of a CDRX cycle.

11. The one or more processors of claim 2, wherein the at least one subsequent uplink grant includes two or more subsequent uplink grants, transmitting the second data further comprising:
splitting the second data into a plurality of portions; and
transmitting each of the plurality of portions in response to a respective subsequent uplink grant.

12. The one or more processors of claim 1, wherein the first data is audio data and/or video data, and the second data is background data.

13. A method, comprising:
receiving an uplink grant associated with pre-scheduling from a base station;
in response to the uplink grant, transmitting first data having a first priority to the base station;
determining whether there is a remaining uplink resource associated with the uplink grant; and
in response to determining that there is the remaining uplink resource, transmitting second data having a second priority to the base station using the remaining uplink resource, wherein the second priority is lower than the first priority.

14. The method of claim 13, further comprising:
in response to determining that there is no remaining uplink resource,
receiving, from the base station, at least one subsequent uplink grant associated with the pre-scheduling; and
in response to receiving the at least one subsequent uplink grant, transmitting the second data to the base station.

15. The method of claim 13, further comprising:
in response to determining that there is no remaining uplink resource,
transmitting a scheduling request (SR) or a Buffer Status Report (BSR) to the base station;
in response to transmitting the SR or the BSR to the base station, receiving a second uplink grant; and
in response to receiving the second uplink grant, transmitting the second data to the base station.

16. The method of claim 13, further comprising:
determining whether a size of the remaining uplink resource is greater than a data size of the second data; and
in response to determining that the size of the remaining uplink resource is greater than the data size of the second data, transmitting the second data to the base station.

17. A user equipment (UE), comprising baseband circuitry and one or more storage devices on which are stored instructions that are operable, when executed by the baseband circuitry, to cause the baseband circuitry to perform operations comprising:
receiving an uplink grant associated with pre-scheduling from a base station;
in response to the uplink grant, transmitting first data having a first priority to the base station;
determining whether there is a remaining uplink resource associated with the uplink grant; and
in response to determining that there is the remaining uplink resource, transmitting second data having a second priority to the base station using the remaining uplink resource, wherein the second priority is lower than the first priority.

18. The UE of claim 17, the operations further comprising:
in response to determining that there is no remaining uplink resource,
receiving, from the base station, at least one subsequent uplink grant associated with the pre-scheduling; and
in response to receiving the at least one subsequent uplink grant, transmitting the second data to the base station.

19. The UE of claim 17, the operations further comprising:
in response to determining that there is no remaining uplink resource,
transmitting a scheduling request (SR) or a Buffer Status Report (BSR) to the base station;
in response to transmitting the SR or the BSR to the base station, receiving a second uplink grant; and
in response to receiving the second uplink grant, transmitting the second data to the base station.

20. The UE of claim 17, the operations further comprising:
determining whether a size of the remaining uplink resource is greater than a data size of the second data; and
in response to determining that the size of the remaining uplink resource is greater than the data size of the second data, transmitting the second data to the base station.
